(19) United States
(12) Patent Application Publication
(10) Pub. No.: US 2017/0238050 A1
(43) Pub. Date: Aug. 17, 2017

(54) METHOD FOR TRANSMITTING AND RECEIVING DATA USING HDMI AND DEVICE THEREFOR

(71) Applicant: LG ELECTRONICS INC., Seoul (KR)

(72) Inventors: Hyunsik YANG, Seoul (KR); Dokyun KIM, Seoul (KR); Hyeonjae LEE, Seoul (KR); Jangwoong PARK, Seoul (KR); Jinkwon LIM, Seoul (KR)

(73) Assignee: LG ELECTRONICS INC., Seoul (KR)

(21) Appl. No.: 15/518,693

(22) PCT Filed: Oct. 13, 2015
(86) PCT No.: PCT/KR2015/010752

§ 371 Date: Apr. 12, 2017

Related U.S. Application Data
(60) Provisional application No. 62/063,392, filed on Oct. 13, 2014.

(51) Int. Cl. H04N 21/439; H04N 21/437; H04N 21/435; H04N 21/4363; H04N 21/61

(52) U.S. Cl. CPC H04N 21/4396; H04N 21/43635; H04N 21/615; H04N 21/435; H04N 21/437

(57) ABSTRACT

A method for transmitting and receiving data using a High Definition Multimedia Interface (HDMI) performed by a source device according to an embodiment of the present invention may include connecting to a sink device through the HDMI; receiving Extended Display Identification Data (EDID) information from the sink device; parsing the received EDID information, and determining an operating parameter; and transmitting a message instructing to execute a video mute function to the sink device.

### TECHNICAL FIELD

The present invention relates to a method and apparatus for transmitting and receiving data using a High Definition Multimedia Interface (HDMI), and more particularly, to a method and apparatus for performing a video mute function of a sink device through a source device.

### BACKGROUND ART

HDMI is an interface/standard that develops a Digital Visual Interface (DVI) which is an interface standard of personal computers and displays for a use of AV electronic products. Since the HDMI transmits video/audio from a player to a display device without compressing it, there is very little latency between a source device and a sink device. And the HDMI has high format compatibility since the HDMI does not require separate decoder chip or software. In addition, the HDMI is available to make wirings between AV devices be simplified, which were complicated because video signals, audio signals and control signals are transmitted on only one cable, and the HDMI provides a High-bandwidth Digital Content Protection (HDCP) technique, thereby providing the copyright protection function.

### DISCLOSURE

### Technical Problem

Previously, a video mute function of a sink device was unable to be controlled through a source device connected via a HDMI. Accordingly, there was an inconvenience that a user should directly manipulate a sink device in order to control the video mute function of a sink device.

### Technical Solution

In order to solve the technical problem, a method for transmitting and receiving data using a High Definition Multimedia Interface (HDMI) performed by a source device according to an embodiment of the present invention may include being connected to a sink device through the HDMI; receiving Extended Display Identification Data (EDID) information from the sink device; parsing the received EDID information, and determining an operating parameter; and transmitting a message instructing to execute a video mute function to the sink device.

In addition, the method for transmitting and receiving data performed by a source device may further include receiving video mute state information of the sink device.

In addition, receiving the video mute state information may be receiving the video mute state information in response to the message instructing to execute the video mute function.

In addition, In addition, the method for transmitting and receiving data performed by a source device may further include requesting the video mute state information to the sink device, and receiving the video mute state information may be receiving the video mute state information in response to the request.

In addition, the method for transmitting and receiving data performed by a source device may further include transmitting a message instructing to terminate the video mute function to the sink device.

In addition, the message instructing to execute the video mute function may be transmitted as a CEC message format.

In addition, a method for transmitting and receiving data using a High Definition Multimedia Interface (HDMI) performed by a sink device according to another embodiment of the present invention may include being connected to a source device through the HDMI; transmitting Extended Display Identification Data (EDID) information from the source device; and receiving a message instructing to execute a video mute function from the source device.

In addition, the method for transmitting and receiving data performed by a sink device may further include transmitting video mute state information of the sink device to the source device.

In addition, transmitting the video mute state information may be transmitting the video mute state information to the source device in response to the message instructing to execute the video mute function.

In addition, the method for transmitting and receiving data performed by a sink device may further include the video mute state information being requested from the source device, and transmitting the video mute state information may be transmitting the video mute state information to the source device in response to the request.

In addition, the method for transmitting and receiving data performed by a sink device may further include receiving a message instructing to terminate the video mute function to the sink device from the source device.

In addition, the method for transmitting and receiving data performed by a sink device may further include receiving a Consumer Electronic Control (CEC) message from the source device; determining whether to execute the video mute function when performing an instruction included in the received CEC message; and terminating or maintaining the execution of the video mute function based on a result of the determination.

In addition, the method for transmitting and receiving data performed by a sink device may further include receiving an external input; and terminating the execution of the video mute function.

In addition, the message instructing to execute the video mute function may be transmitted as a CEC message format.

In addition, a source device for transmitting and receiving data using a High Definition Multimedia Interface (HDMI) according to another embodiment of the present invention may include an HDMI transmitter for transmitting and receiving data through the HDMI; and a MICOM for generating a signal for a data transmission, where the source device is configured to perform: being connected to a sink device through the HDMI, receiving Extended Display Identification Data (EDID) information from the sink device, parsing the received EDID information, and determining an operating parameter, and transmitting a message instructing to execute a video mute function to the sink device.

In addition, the source device may receive video mute state information of the sink device.

In addition, the message instructing to execute the video mute function may be transmitted as a CEC message format.

In addition, a sink device for transmitting and receiving data using a High Definition Multimedia Interface (HDMI) according to another embodiment of the present invention may include an HDMI transmitter for transmitting and receiving data through the HDMI; and a MICOM for generating a signal for a data transmission, where the sink device is configured to perform: being connected to a source device through the HDMI, transmitting Extended Display Identification Data (EDID) information from the source device, and receiving a message instructing to execute a video mute function from the source device.

In addition, the sink device may transmit video mute state information of the sink device to the source device.

In addition, the message instructing to execute the video mute function may be transmitted as a CEC message format.

### Technical Effects

The present invention has an effect of controlling the video mute function of a sink device more easily and efficiently through a source device.

In addition, it is available to control the video mute function of a sink device through a source device, and accordingly, the present invention has an effect beneficial for decreasing the power consumption occurred owing to an unnecessary video output of the sink device using the source device.

Further, the beneficial effect of the present invention will be described in detail in the Best Mode for Invention.

### DESCRIPTION OF DRAWINGS

FIG. 1 is a block diagram illustrating an HDMI system according to an embodiment of the present invention.

FIG. 2 is a block diagram of an HDMI CEO system according to an embodiment of the present invention.

FIGS. 3 and 4 are diagrams illustrating a CEC message structure according to an embodiment of the present invention.

FIG. 5 is a flowchart for a method for transmitting and receiving data between a source device and a sink device according to an embodiment of the present invention.

FIG. 6 is a flowchart illustrating a method for executing the video mute function according to a first embodiment of the present invention.

FIG. 7 is a flowchart illustrating a method for executing the video mute function according to a second embodiment of the present invention.

FIG. 8 is a flowchart illustrating a method for executing the video mute function according to an embodiment of the present invention.

FIG. 9 is a flowchart illustrating a method for terminating the video mute function according to a first embodiment of the present invention.

FIG. 10 is a flowchart illustrating a method for terminating the video mute function according to a first embodiment of the present invention.

FIG. 11 is a flowchart illustrating a method for terminating the video mute function according to a second embodiment of the present invention.

FIG. 12 is a flowchart illustrating a method for terminating the video mute function according to a second embodiment of the present invention.

FIG. 13 is a flowchart illustrating a method for terminating the video mute function according to a third embodiment of the present invention.

FIG. 14 is a flowchart illustrating a method for terminating the video mute function according to a third embodiment of the present invention.

FIG. 15 is a table representing an arrangement of command formats transmitted and received between a source device and a sink device according to an embodiment of the present invention.

FIG. 16 is a flowchart of a source device and a sink device for controlling the video mute function by transmitting and receiving a CEC message.

FIG. 17 illustrates a CEC message format according to an embodiment of the present invention.

### BEST MODE FOR INVENTION

Although the terms used in the present specification are selected as general terms which are currently used widely as possible while considering functions in the present specification, the terms may be changed according to intentions of those skilled in the art, practices and advents of new techniques. In addition, in a special case, a term is discretionally selected by the applicant. In this case, the meaning of the term will be described in the corresponding embodiment of the detailed description. Accordingly, the terms used in the present specification should be interpreted based on the substantive meanings of the terms and based on the description throughout the present specification, not based on simple nominal terms.

Further, the embodiments will be described in detail by reference to the accompanying drawings and the contents shown in the accompanying drawings, but the present invention is not restricted or limited to the embodiments.

Hereinafter, the preferred embodiment of the present invention will be described in more detail by reference to the accompanying drawings.

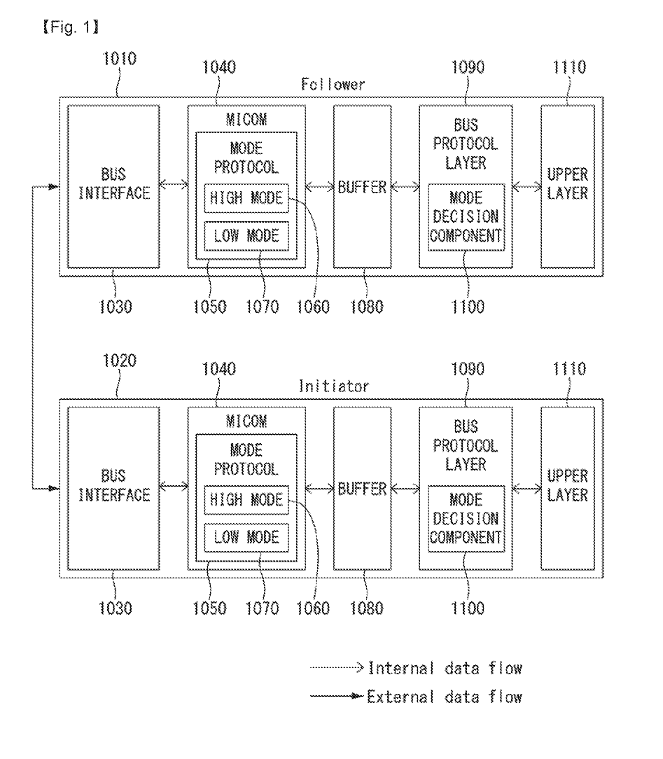

FIG. 1 is a block diagram illustrating an HDMI system according to an embodiment of the present invention.

Referring to FIG. 1, the High Definition Multimedia Interface (HDMI) system may include an initiator 1020, which is a device for transmitting a Consumer Electronic Control (CEO) message, and a follower 1010, which is a device for receiving and responding to the CEC message.

The initiator 1020 represents a device for initiating a CEC command, and controlling the follower by forwarding the CEO command to the follower. The follower 1010 may represent a device for responding to the received CEC command, and notify a result by performing the CEC command.

Each of the devices may include a bus interface 1030, a MICOM 1040, a buffer 1080, a bus protocol layer 1090 and an upper layer 1110. That is, both of the devices may include the same elements commonly. Here, the elements commonly included in both of the devices are logical or physical units in the device that performs a specific operation, and an element may correspond to a single device or a plurality of devices, or a single element or a plurality of elements may correspond to a single device. Hereinafter, the elements commonly included in both of the devices will be described in detail.

The bus interface 1030 represents a physical device that enables to transmit a message or data such as a command between both of the devices, a request, an action, a response, and the like.

The MICOM 1040 represents a physical device for generating a signal for a data transmission or managing a transmission priority, retransmission for reliable transmission, and so on. The MICOM 1040 includes a mode protocol 1050 for managing an efficient resource required for high speed and low speed transmission.

The mode protocol 1050 represents a protocol for performing an efficient resource management required for high speed/low speed transmission. A high mode 1060 represents a logical device in charge of a process related to a high speed data transmission of a bus structure connection. A low mode 1070 represents a logical device in charge of a process related to a low speed data transmission of a bus structure connection.

The buffer 1080 represents a physical device for improving the reliability of transmitted message or data, and storing the message or data temporarily.

The bus protocol layer 1090 represents a logical device for processing transmitted data through the transmission method of a bus structure, and forwards the required information to a high layer. The bus protocol layer 1090 may include a Mode Decision Component 1100.

The upper layer 1110 represents a logical/physical device for processing a command actually.

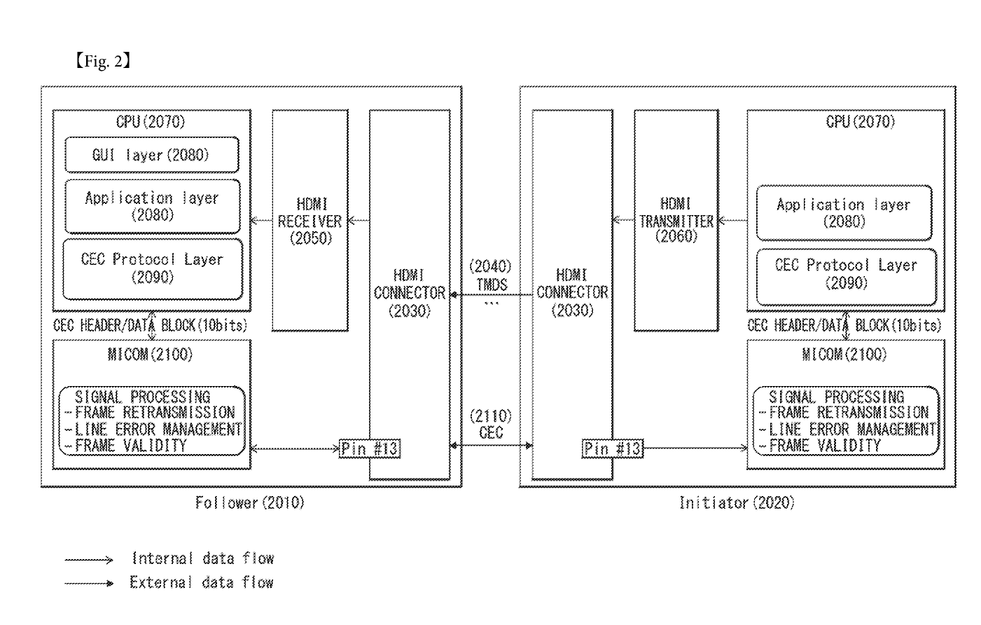

FIG. 2 is a block diagram of an HDMI CEO system according to an embodiment of the present invention.

The HDMI Consumer Electronic Control (HDMI CEC) means a protocol that provides a function for a plurality of multimedia products to control several products in one action to a user in a network connected by an HDMI cable.

Referring to FIG. 2, the HDMI CEO system may include a follower 2010 and an initiator 2020, largely. The follower 2010 may include an HDMI connector 2030, an HDMI receiver 2050, a Central Processing Unit (CPU) 2070 and a MICOM 2100. The initiator 2020 may include an HDMI connector 2030, an HDMI transmitter (or an HDMI receiver) 2060, a CPU 2070 and a MICOM 2100.

The HDMI connector 2030 may include five types of connectors such as types A, B, C, D and E. For example, type A may represent a general HDMI connector of 19 pins, type B may represent a connector for transmitting a UHD picture of 29 pins, type C may represent a mini connector of 19 pins, type D may represent a micro connector of 19 pins, and type E may represent a connector for an automobile.

The HDMI transmitter 2060 and the HDMI receiver 2050 may perform a transmission through a plurality of Transition Minimized Differential Signaling (TMDS) data transmission channel 2040 and a Consumer Electronics Control (CEC) channel 2110 that transfers the multimedia information using the HDMI connector 2030. In addition, the HDMI transmitter 2060 and the HDMI receiver 2050 may perform a communication through the control channels such as a cluck channel (not shown), a Display Data Channel (not shown), a utility channel (not shown), and a Hot Plug Detect (HPD) channel (not shown).

The TMDS channel 2040 may include three data transmission channels, and transmits video and audio.

The CEC channel 2110 is a control channel for forwarding the CEC protocol, which is a control command that enables to control the devices connected through HDMI using a TV remote controller. Using the function, the one touch play is available. That is, without controlling each of the devices connected via the HDMI separately such as the function of performing a playback of the play device connected using a TV remote controller, each of the devices may be controlled by a single remote controller, thereby increasing a user convenience.

The CPU 2070 of the follower 2010 may include a Graphic User Interface (GUI) layer 2080, an application layer 2080 and a CEC protocol layer 2090. The CPU 2070 of the initiator 2020 may include an application layer 2080 and a CEC protocol layer 2090. The GUI layer 2080 may process data such that the data received through the HDMI receiver 2050 is to be outputted through the graphic user interface.

The application layer 2080 may process data by the method defined by a user.

The CEC protocol layer 2090 processes the transmitted CEC data and forwards the required information and the like to a high layer.

The CPU 2070 may perform a communication by transmitting and receiving CEC header/data block (10 bits) with the MICOM 2100 described below.

The MICOM 2100 may generate a signal for a data transmission or manage the transmission priority, the retransmission for a reliable transmission, and so on. For example, the MICOM 2100 may perform a frame re-transmission, a line error handling, a frame validation, and the like. In addition, the MICOM 2100 may perform the role of an interface that performs an HDMI CEO signal processing through a data communication in a unit of frame with the CPU.

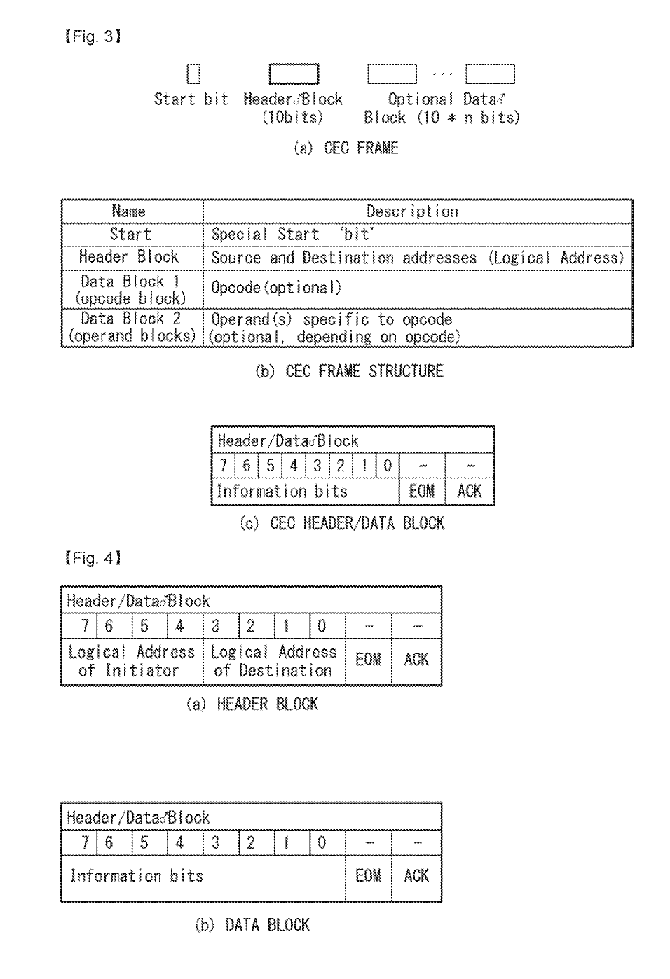

FIGS. 3 and 4 are diagrams illustrating a CEC message structure according to an embodiment of the present invention.

The CEO enables the devices to be connected through the HDMI using a single remote controller. When the HDMI is connected, each of the devices has a physical address, and the devices that support the CEC have logical addresses additionally.

Each of the devices may exchange a CEC message through a CEC line when an event occurs, and each of the messages may have the following function.
One Touch Play: a playback is started by a single button click, and a device is changed to an active source state.
Routing Control: Control a routing of an HDMI network when a CEC switch is used
System Standby: Switch all connected devices into a standby mode
One Touch Record: Function control for recording the contents displayed in TV
Preset Transfer: Transmit a configuration of a tuner channel to another TV set
Timer Programming: Configure a timer of a device from another device
System Information: Setting so as to use the same OSD and menu language of a TV in a device
Deck Control: Control a playback device from another device
Tuner Control: Control a tuner of another device
OSD Display: Transmit a text to show it on a screen of a TV set from a device
Device OSD Name Transfer: Transmit a configured device name to a TV set
Device Menu Control: Control the menus of a device by a TV remote controller
Remote Control Pass Through: Transmit the contents received from a remote controller to another device
Vendor Specific Commands: Command defined by a manufacturer

The CEC message may be transmitted through a CEC frame.

Referring to FIGS. 3 and 4, a CEO frame may include a start bit, a header block and an optional data block (first and second data blocks). A size of each data block may be 10 bits, and the maximum size of the remaining block except the start bit may be 16*10 bits.

The CEC header block may include an address (logical address) of a source device (or an initiator) and an address (logical address) of a destination, the first data block may include an Opcode block, and the second data block may include an operand block. Here, the opcode may mean a name used for distinguishing a message. The opcode and the operand block may be selectively applied. The operand block may be determined based on the opcode.

Each of all data blocks and header blocks may include an information bits field, an End of Message (EOM) field and an Acknowledge (ACK) field.

The information bits field may include a data, an opcode or an address. The End of Message (EOM) field is a bit for notifying whether it is the last block of a message. For example, when the End of Message (EOM) field value is ‘0’, it may mean one or more data blocks are additionally existed (or not the last block of a message), and when the End of Message (EOM) field value is ‘1’, it may mean a message is completed (or the last block of a message).

The ACK field is forwarded by setting ‘1’ in the initiator, and may be used for notifying that a message is received by showing ‘0’ in the follower.

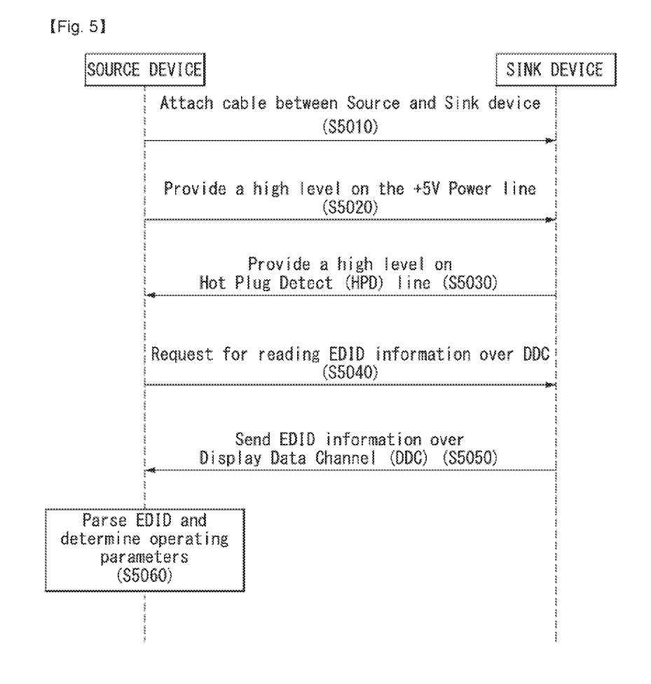

FIG. 5 is a flowchart for a method for transmitting and receiving data between a source device and a sink device according to an embodiment of the present invention. Each step of the flowchart described below may be selectively applied to embodiments or an additional step may be added.

Referring to FIG. 5, firstly, a sink device and a source device may be connected via a cable (HDMI cable) (S5010).

Next, the source device may provide a high level to a power line of +5V (S5020). More particularly, the source device may switch the power line of +5V from a low level to a high level, and apply a current. Through this, the source device may operate the EEPROM in which Extended Display Identification Data (EDID) information of the sink device is stored and the related circuit.

Then, the sink device may provide a high level to a Hot Plug Detect line (S5030). More particularly, the sink device may notify that a cable is normally connected by switching the HPD line from a low level to a high level, and the EDID related circuit is activated and the EDID information is accessible, to the source device 1010.

Next, the source device may request to readout the EDID information through a DDC to the sink device (S5040). More particularly, the source device may identify that the HPD line is switched to the high level through step, S5030, and may request for readout of the EDID information to the sink device through the DDC.

Then, the sink device may transmit the EDID information through the DDC (S5050). In more particular, the sink device may transmit the EDID information stored in the EEPROM to the source device through the DDC, in response to the EDID readout request of the source device.

Next, the source device may parse the EDID (or EDID information) and determine an operation parameter (S1060). More particularly, the source device may parse the received EDID information, and may determine the operation parameter (timing, format, etc.) of the data (e.g., Audio/Video (A/V) data) that is going to be transmitted to the sink device. In addition, the source device may transmit the operation parameter determined in relation to the data to be transmitted to the sink device.

However, in the case of the embodiment described above, the source device does not provide the function of controlling the video mute function of the sink device. Accordingly, there exists an inconvenience for a user to manipulate the sink device separately from the source device in order to configure the video mute function of the sink device (e.g., a user configures the sink device to be power saving mode or turns off the power of a display of the sink device). Here, the video mute function may mean a function of stopping (or deactivating) the video output, for example, shut down the power of a display. Accordingly, in order to solve the problem of inconvenience, hereinafter, a control method that enables to control the video mute function of the sink device through the source device will be described in detail.

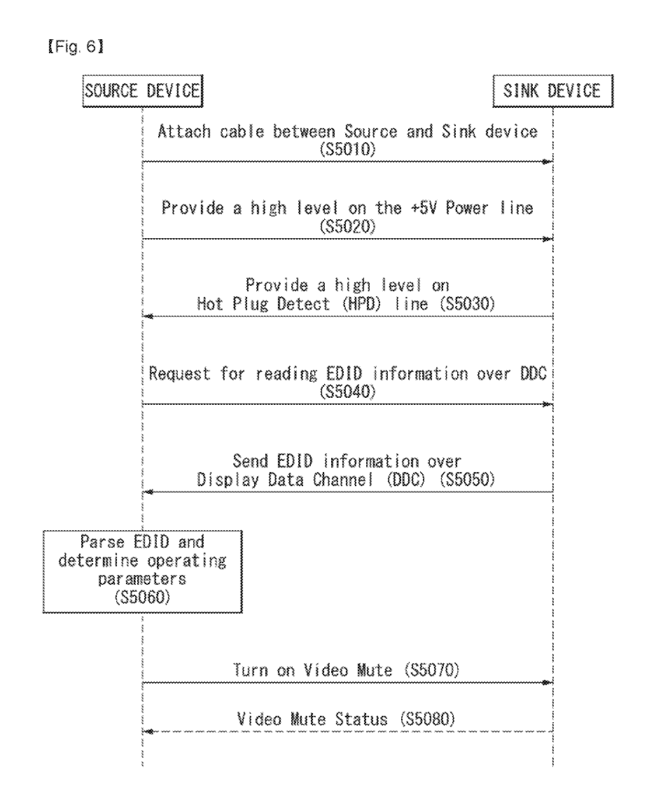

FIG. 6 is a flowchart illustrating a method for executing the video mute function according to a first embodiment of the present invention. In the flowchart, the description for steps, S5010 to S5060 is the same as the description in relation to FIG. 5, and accordingly, the overlapped description will be omitted.

Referring to FIG. 6, a source device may turn on the video mute function of a sink device (S5070). More particularly, the source device may control the sink device such that the sink device is to execute the video mute function. For this, the source device may transmit a command to instruct the execution of the video mute function to the sink device. The sink device may execute the video mute function following the received command.

Next, the sink device may transmit the video mute state to the source device (S5080). More particularly, in response to the command for executing the video mute function received from the source device, the sink device may transmit the information (hereinafter, ‘video mute state information’) of the current video mute state of the sink device. Accordingly, in the embodiment, the sink device may transmit the video mute state information that identifies that the video mute function is currently executing to the source device.

The step, S5080 may be selectively applied according to an embodiment. Accordingly, the sink device may transmit or not transmit the current video mute function information according to the embodiment.

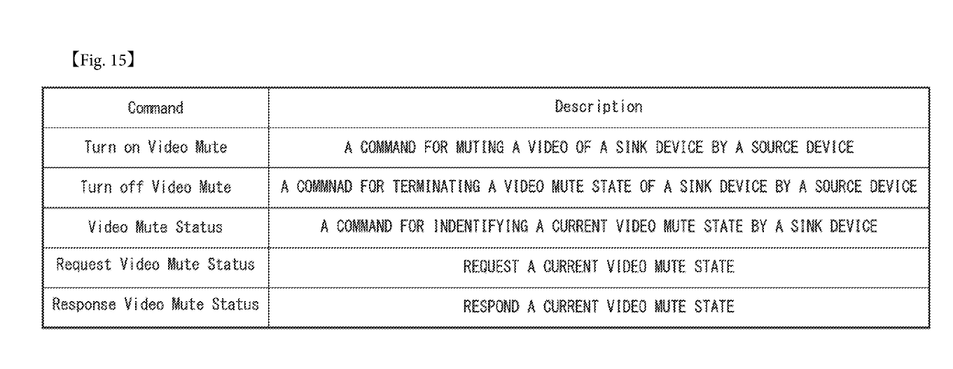

The command and the state information described above may be transmitted and received by being defined as a CEO message, and this will be described in detail with reference to FIGS. 15 to 17 below.

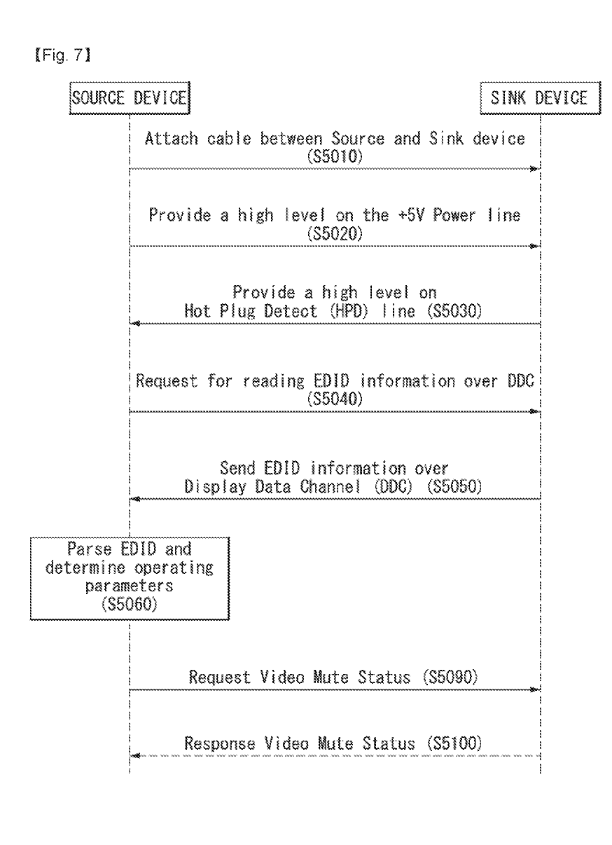

FIG. 7 is a flowchart illustrating a method for executing the video mute function according to a second embodiment of the present invention. In the flowchart, the description for steps, S5010 to S5060 is the same as the description in relation to FIG. 5, and accordingly, the overlapped description will be omitted.

Referring to FIG. 7, a source device may request the video mute state to a sink device (S5090). More particularly, the source device may request the information of the current video mute state of the sink device to the sink device. For example, the source device may request the information on whether the sink device is currently executing the video mute function to the sink device.

Next, the sink device may respond with the video mute state (S5100). In more particularly, the sink device is requested to indicate the video mute state from the source device, and as a response to the corresponding request, may respond with the video mute state with the current video mute state of the sink device. For example, in response to the request of the source device, the sink device may transmit the video mute state information representing that the video mute function is currently executed (or the video mute state information representing that the video mute function is not currently executed) to the source device.

This step, S5100 may be selectively applied according to an embodiment. Accordingly, even in the case that the sink device is requested to indicate the video mute state from the source device according to an embodiment, the sink device may or may not transmit the current video mute state information to the source device.

The video mute state request and the video mute state response described above may be transmitted or received by being defined as a CEC message, and this will be described in detail in relation to FIGS. 15 to 17.

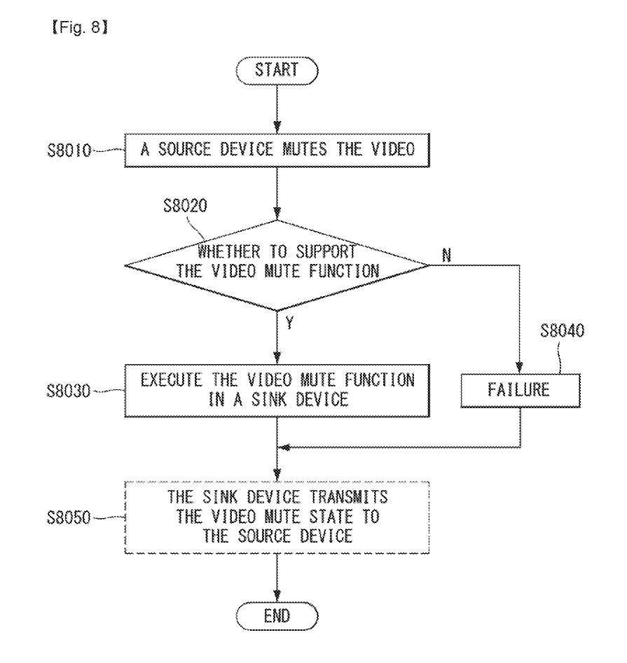

FIG. 8 is a flowchart illustrating a method for executing the video mute function according to an embodiment of the present invention. The contents described in relation to FIGS. 6 and 7 may be identically applied to this flowchart, and the overlapped description will be omitted.

Referring to FIG. 8, firstly, a source device may mute the video of a sink device (S8010). More particularly, the source device may transmit the command that instructs to execute the video mute function to the sink device.

Next, the sink device may determine whether to support the video mute function (S8020). In more particular, according to the command of executing the video mute function, the sink device may determine whether to support the video mute function.

In the case that the sink device supports the video mute function, the sink device may execute the video mute function (S8030). More particularly, in the case that the sink device supports the video mute function, the sink device may execute the video mute function according to the instruction to execute the video mute function of the source device.

On the contrary, in the case that the sink device does not support the video mute function, the sink device is unable to execute the video mute function, and the execution of the video mute function may be failed (S8040).

Next, the sink device may transmit the video mute state to the source device (S8050). More particularly, the sink device may transmit the video mute state information, which is the information on whether the sink device is currently executing the video mute function, to the source device. In the case that the sink device supports the video mute function and is executing the video mute function according to the command of the source device, the sink device may transmit the video mute state information, which is the information on whether the sink device is currently executing the video mute function, to the source device. On the contrary, in the case that the sink device does not support the video mute function and the sink device fails to execute the video mute function according to the command of the source device, the sink device may transmit the video mute state information, which is the information on whether the sink device is not currently executing the video mute function, to the source device.

This step, S8050 may be selectively applied according to an embodiment. Accordingly, the sink device may or may not transmit the current video mute state information to the source device.

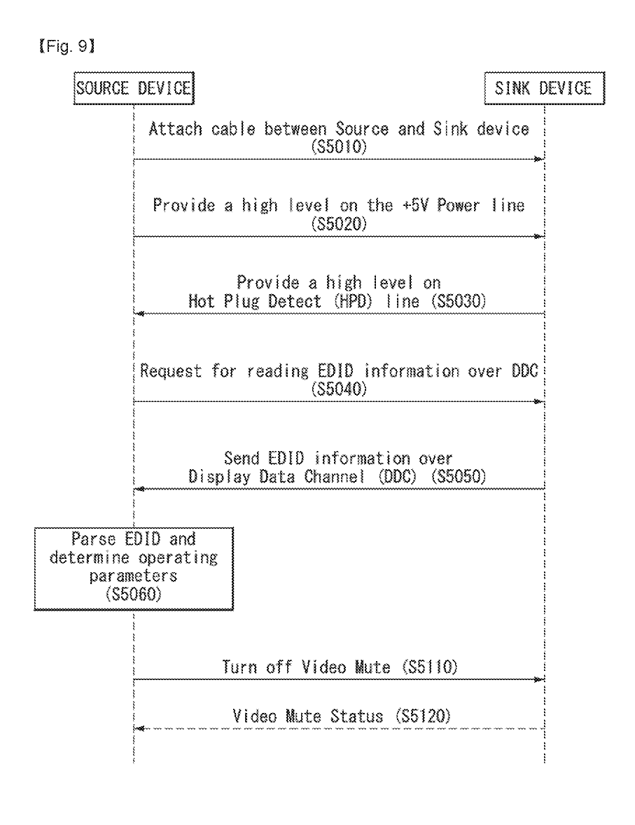

FIG. 9 is a flowchart illustrating a method for terminating the video mute function according to a first embodiment of the present invention. In this flowchart, the description for steps, S5010 to S5060 is the same as the description in relation to FIG. 5 described above, and accordingly, the overlapped description will be omitted.

Referring to FIG. 9, a source device may turn off the video mute function (S5110). More particularly, the source device may control the sink device such that the sink device is to terminate the video mute function. For this, the source device may transmit a command to instruct the termination of the video mute function to the sink device. The sink device may terminate the video mute function following the received command.

Next, the sink device may transmit the video mute state to the source device (S5120). More particularly, in response to the command for terminating the video mute function received from the source device, the sink device may transmit the current video mute state information of the sink device. Accordingly, in the embodiment, the sink device may transmit the video mute state information that identifies that the video mute function is terminated (or the video mute function is not executed) to the source device.

The step, S5120 may be selectively applied according to an embodiment. Accordingly, the sink device may transmit or not transmit the current video mute function information according to the embodiment.

The command and the state information described above may be transmitted and received by being defined as a CEO message, and this will be described in detail with reference to FIGS. 15 to 17 below.

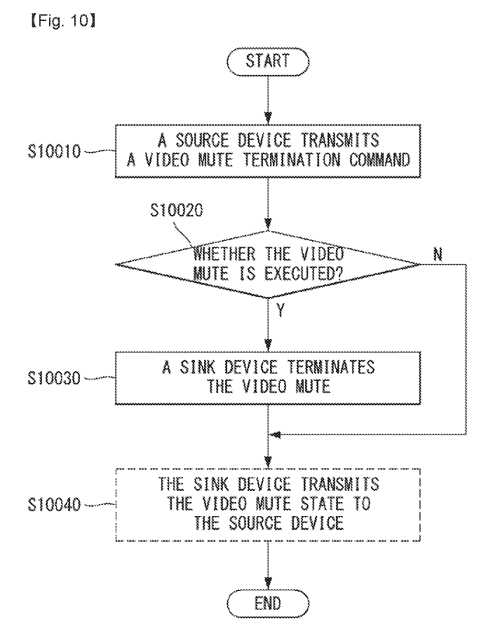

FIG. 10 is a flowchart illustrating a method for terminating the video mute function according to a first embodiment of the present invention. The contents described in relation to FIG. 9 may be identically applied to this flowchart, and the overlapped description will be omitted.

Referring to FIG. 10, a source device may transmit a video mute termination command to a sink device (S10010). More particularly, the source device may transmit the video mute termination command to terminate the video mute function of the sink device to the sink device.

Next, the sink device may determine whether the video mute is executed (S10020). In more particular, the sink device may determine whether the sink device is currently executing the video mute function by receiving the video mute termination command from the source device.

In the case that the sink device determines that the video mute function is executed, the sink device may terminate the video mute function which is currently executed (S10030). Next, the sink device may transmit the video mute state to the source device (S10040). More particularly, the sink device may transmit the video mute state information, which is the information on whether the sink device is currently executing the video mute function, to the source device. In this embodiment, the sink device may transmit the video mute state information, which is the information on whether the sink device is not currently executing the video mute function (or the video mute function is terminated), to the source device.

On the contrary, in the case that the sink device determines that the sink device is not currently executing the video mute function, the sink device may perform step, S10040 described above. That is, the sink device may transmit the video mute state information representing that the sink device is not currently executing the video mute function to the source device.

The step, S10040 described above may be selectively applied according to an embodiment. Accordingly, the sink device may or may not transmit the current video mute state information to the source device.

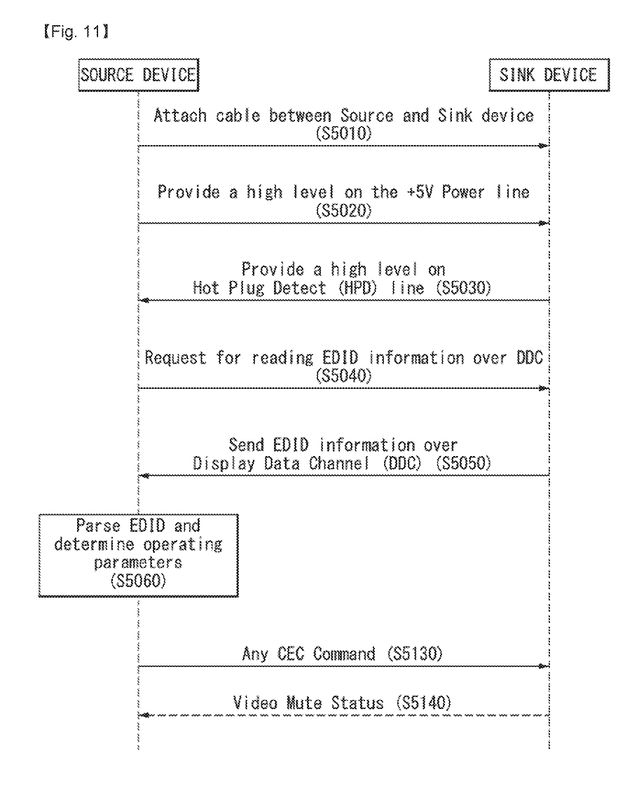

FIG. 11 is a flowchart illustrating a method for terminating the video mute function according to a second embodiment of the present invention. In this flowchart, the description for steps, S5010 to S5060 is the same as the description in relation to FIG. 5 described above, and accordingly, the overlapped description will be omitted.

Referring to FIG. 11, a source device may transmit a CEC command to a sink device (S5130). More particularly, the source device may transmit the CEC command for controlling the sink device to the sink device. In this case, the CEC command may correspond to a command except the command for controlling the video mute function of the sink device. For example, the CEC command is not in direct relation to the video mute function, but may correspond to various commands for controlling (changing a channel, adjusting loudness, etc.) the sink device. The sink device that receives such a CEC command may determine whether to terminate the video mute function based on the received CEC command, and maintain or terminate the execution of the video mute function.

Next, the sink device may transmit the video mute state to the source device (S5140). More particularly, in response to the CEC command received from the source device, the sink device may transmit the current video mute state information of the sink device. In the case that the video mute function is maintained based on the CEO command received from the source device in the previous step, S5130, the sink device may transmit the video mute state information that identifies that the video mute function is executing to the source device. Otherwise, in the case that the video mute function is terminated based on the CEC command received from the source device in the previous step, S5130, the sink device may transmit the video mute state information that identifies that the video mute function is not executing (or the video mute function is terminated) to the source device.

The step, S5140 may be selectively applied according to an embodiment. Accordingly, the sink device may transmit or not transmit the current video mute function information according to the embodiment.

The CEC command and the state information described above may be transmitted and received by being defined as a CEC message, and this will be described in detail with reference to FIGS. 15 to 17 below.

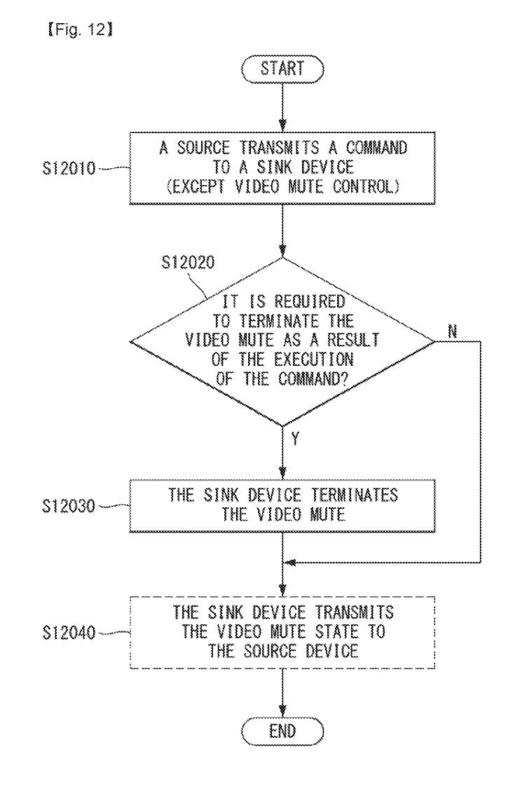

FIG. 12 is a flowchart illustrating a method for terminating the video mute function according to a second embodiment of the present invention. The contents described in relation to FIG. 11 may be identically applied to this flowchart, and the overlapped description will be omitted.

Referring to FIG. 12, a source may transmit a command to a sink device (S12010). In this case, the command may not be in direct relation with the control of the video mute function of the sink device, but may correspond to various CEC commands for controlling the sink device.

Next, the sink device may determine whether it is required to terminate the video mute function as a result of the execution of the received command (S12020). For example, in the case that it is required to output a video in order to execute the received command, the sink device may determine that it is required to terminate the video mute function. On the contrary, in the case that it is not required to output a video in order to execute the received command, the sink device may determine that it is not required to terminate the video mute function.

In the case that the sink device determines that it is required to terminate the video mute function as a result of the execution of the received command, the sink device may terminate the video mute function which is executing (S12030).

Next, the sink device may transmit the video mute state to the source device (S12040). More particularly, the sink device may transmit the video mute state information, which is the information on whether the sink device is currently executing the video mute function, to the source device. Since the sink device terminated the video mute function in the previous step, the sink device may transmit the video mute state information, which is the information on whether the sink device is not currently executing the video mute function (or the video mute function is terminated), to the source device.

On the contrary, the sink device may determine whether it is not required to terminate the video mute function as a result of the execution of the received command, the sink device may maintain the execution of the video mute function which is executing. Further, the sink device may transmit the video mute state to the source device (S12040). In this case, the sink device may transmit the video mute state information that identifies that the video mute function is executing (or the video mute function is not terminated) to the source device.

The step, S12040 may be selectively applied according to an embodiment. Accordingly, the sink device may transmit or not transmit the current video mute function information according to the embodiment.

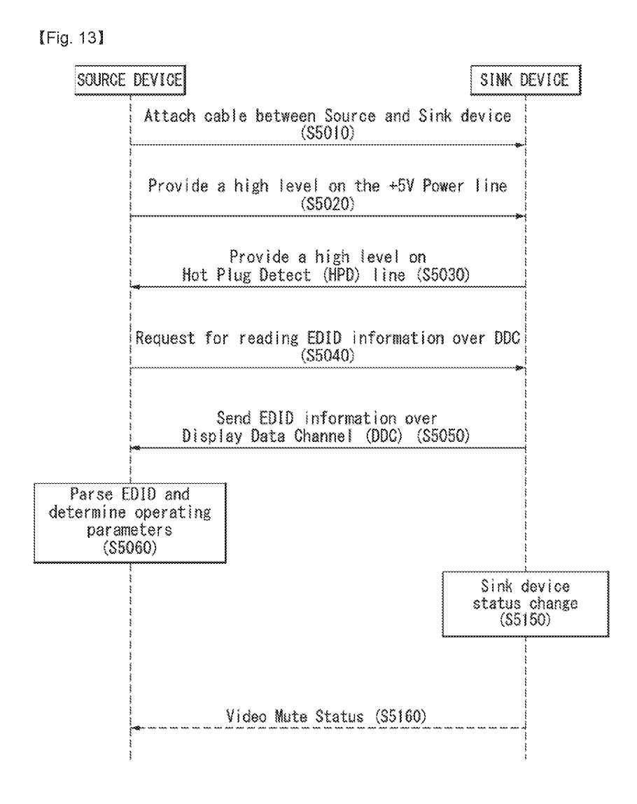

FIG. 13 is a flowchart illustrating a method for terminating the video mute function according to a third embodiment of the present invention. In this flowchart, the description for steps, S5010 to S5060 is the same as the description in relation to FIG. 5 described above, and accordingly, the overlapped description will be omitted.

Referring to FIG. 13, a state of a sink device may be changed (S5150). For example, when the sink device receives an external input (e.g., various user inputs for the sink device such as a remote controller input for the sink device), the state of the sink device may be changed. In the case that the state is changed, the sink device may terminate the video mute function autonomously. Particularly, in the case that the sink device determines that it is required to output a video according to the external input, the sink device may terminate the video mute function which is executing.

Next, the sink device may transmit the video mute state to the source device (S5160). More particularly, the sink device may transmit the video mute state information that identifies that the video mute function is not executing (or the video mute function is terminated) to the source device.

The step, S5160 may be selectively applied according to an embodiment. Accordingly, the sink device may transmit or not transmit the current video mute function information according to the embodiment.

The video mute state information described above may be transmitted and received by being defined as a CEC message, and this will be described in detail with reference to FIGS. 15 to 17 below.

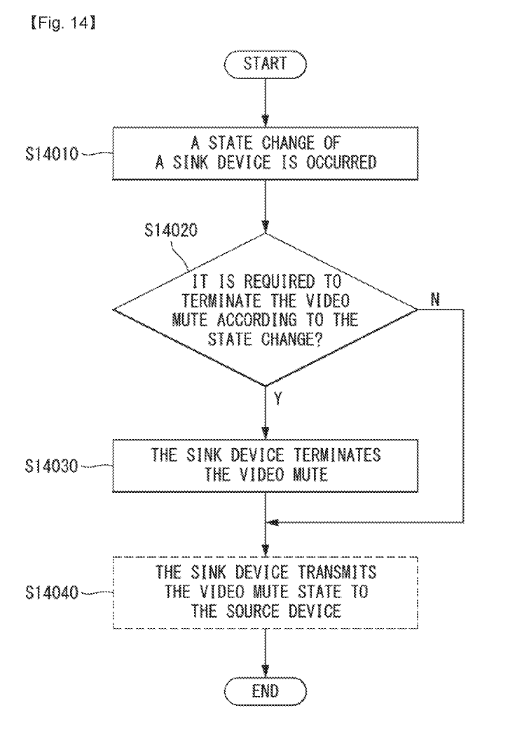

FIG. 14 is a flowchart illustrating a method for terminating the video mute function according to a third embodiment of the present invention. The contents described in relation to FIG. 13 may be identically applied to this flowchart, and the overlapped description will be omitted.

Referring to FIG. 14, a state change of a sink device may be occurred (S14010). For example, when the sink device receives an external input (e.g., various user inputs for the sink device such as a remote controller input for the sink device), the state of the sink device may be changed.

Next, the sink device may determine whether it is required to terminate the video mute function according to the state change (S14020). For example, in the case that the sink device performs a specific command according to the external input, the sink device may determine whether a video output is required.

In the case that the sink device determines that it is required to terminate the video mute function according to the external input, the sink device may terminate the video mute function (S14030).

Next, the sink device may transmit the video mute state to the source device (S14040). More particularly, the sink device may transmit the video mute state information, which is the information on whether the sink device is currently executing the video mute function, to the source device. Since the sink device terminated the video mute function according to the state change in the previous step, the sink device may transmit the video mute state information, which is the information on whether the sink device is not currently executing the video mute function (or the video mute function is terminated), to the source device.

On the contrary, the sink device may determine whether it is not required to terminate the video mute function according to the state change, the sink device may maintain the execution of the video mute function. Further, the sink device may transmit the video mute state to the source device (S14040). In this case, the sink device may transmit the video mute state information that identifies that the video mute function is executing to the source device.

The step, S14040 may be selectively applied according to an embodiment. Accordingly, the sink device may transmit or not transmit the current video mute function information according to the embodiment.

So far, the method for a source device to control the video mute function has been described. Hereinafter, the command format and the CEC message which are transmitted and received in order for a source device to control the video mute function of a sink device will be described in detail.

FIG. 15 is a table representing an arrangement of command formats transmitted and received between a source device and a sink device according to an embodiment of the present invention.

Referring to FIG. 15, a source device may transmit and receive various commands in order for a source device to control the video mute function of a sink device as follows.
Turn on Video Mute: A command for muting a video of a sink device by a source device (or a command transmitted from a source device to a sink device in order to execute the video mute function of a sink device)
Turn off Video Mute: A command for terminating a video of a sink device by a source device (or a command transmitted from a source device to a sink device in order to terminate the video mute function of a sink device)
Video Mute Status: A command for indentifying a current video mute state by a sink device (a command transmitted from a source device to a sink device in order to identify whether a sink device is executing the video mute function currently)
Request Video Mute Status: Request a current video mute state (a command transmitted from a source device to a sink device in order to request the current video mute state information of a sink device)
Response Video Mute Status: Respond a current video mute state (a command transmitted from a source device to a sink device in order to respond the current video mute state information of a sink device; may be transmitted in response to the Request Video Mute Status)

The Turn on Video Mute/Video Mute status command may be applied to the embodiments described in relation to FIGS. 6 and 8.

The Request Video Mute Status/Response Video Mute Status command may be applied to the embodiment described in relation to FIG. 7.

The Turn off Video Mute/Response Video Mute Status command may be applied to the embodiments described in relation to FIGS. 9 and 10.

The Video Mute Status command may be applied to the embodiments described in relation to FIGS. 13 and 14.

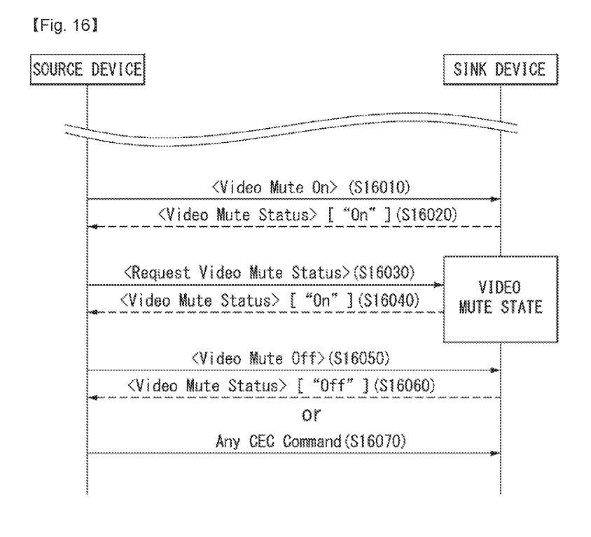

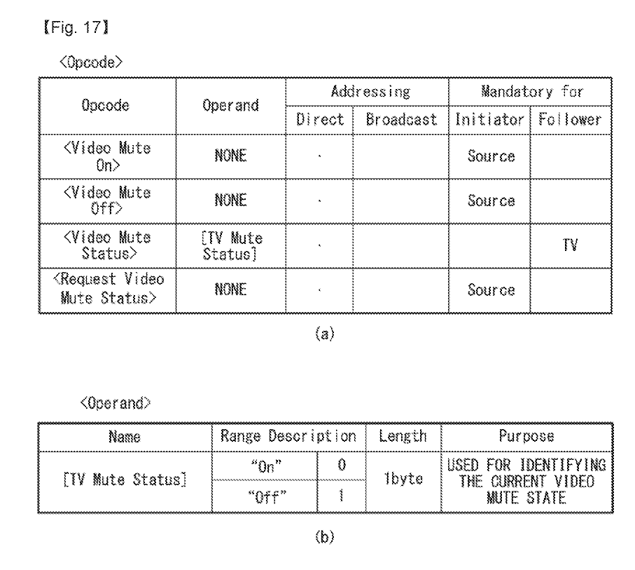

The commands may be transmitted and received by a source device and a sink device by being defined as a CEC message format, and this will be described in detail in relation to FIGS. 16 and 17.

FIG. 16 is a flowchart of a source device and a sink device for controlling the video mute function by transmitting and receiving a CEC message. Especially, FIG. 16 is a flowchart illustrated by integrating the embodiments shown in FIGS. 6 to 12. Accordingly, the contents described in relation to FIGS. 6 to 12 may be identically applied to this flowchart, and the overlapped description will be omitted. In addition, the description for the CEC messages described below will be described in detail in relation to FIG. 17.

Referring to FIG. 16, firstly, a source device may transmit a CEC message (<Video Mute On>) for executing the video mute function of a sink device (S16010). The sink device that receives the corresponding CEC message (<Video Mute On>) may execute the video mute function, in the case that the sink device supports the video mute function.

Next, the sink device may transmit a CEC message (<Video Mute Status> [“On”]) identifying that the video mute function is currently executing to the source device (S16020).

Then, the source device may transmit a CEC message (<Request Video Mute Status>) requesting the current video mute function of the sink device to the source device (S16030).

Next, the sink device may transmit a CEC message (<Video Mute Status> [“On”]) identifying that the video mute function is currently executing to the source device (S16040).

And then, the source device may transmit a CEC message (<Video Mute Off>) for terminating the video mute function of the sink device (S16050). The sink device that receives the corresponding CEC message (<Video Mute Off>) may terminate the video mute function which is executing.

Next, the sink device may transmit a CEC message (<Video Mute Status> [“Off”]) identifying that the video mute function is not executed currently (or the execution of the video mute function is terminated) to the source device (S16060).

Otherwise, instead of steps, S16050 and S16060, the source device may transmit the CEO command (or CEC message) except the video mute function control to the source device (S16070). For example, the CEC command is not in direct relation with the video mute function, but may correspond to the command for controlling (changing a channel, adjusting loudness, etc.) the sink device. The sink device that receives the CEC command may determine whether to terminate the video mute function based on the received CEC command, and may maintain or terminate the execution of the video mute function.

FIG. 17 illustrates a CEC message format according to an embodiment of the present invention.

FIG. 17 shows the embodiment defining the commands and the CEC messages described above, and the CEO message defined in the present invention is defined by the description for the corresponding operation, but not necessarily defined by the same syntax.

An operator may represent a command for sending the CEO command, an opcode may represent a term for distinguishing the CEC message, and an operand may represent data values that correspond to the CEC command/message. Especially, the operand may correspond to the data corresponding to a specific opcode.

First, with reference to FIG. 17(a), the opcodes defined in the present invention will be described.

<Video Mute On>: Execute the video mute function, transmitted from an initiator (source device)

<Video Mute Off>: Terminate the video mute function, transmitted from an initiator (source device)

<Video Mute status>: Transmit the current video mute function, may be transmitted together with the operand [TV Mute Status], transmitted from a follower (or TV (sink device))

<Request Video Mute Status>: Request the current video mute function, transmitted from an initiator

The opcodes described above may be directly transmitted in unicast scheme.

Next, with reference to FIG. 17(b), the operand defined in the present invention will be described.

[TV Mute Status]:
An operand used for identifying the current video mute state
May be transmitted together with the opcode <Video Mute Status>
In the case that the current video mute function is executed (“On”), “0” may be transmitted, and in the case that the current video mute function is not executed (“Off”), “1” may be transmitted.
The length may be 1 byte.

So far, the method has been described for controlling the video mute function of a sink device according to an embodiment of the present invention. The present invention has an effect of controlling the video mute function of a sink device more easily and efficiently through a source device. In addition, the present invention may control the video mute function of a sink device through a source device, and may decrease the power consumption which is occurred owing to an unnecessary video output of the sink device.

Although the present invention has been described by separate drawings for the convenience of description, it is also possible to design so as to implement a new embodiment by merging the embodiments described for each drawing. In addition, the construction and method of the embodiments described above are not limitedly applied to the display device, but a part or the whole of the embodiments may be selectively combined and constructed so as to implement various modifications.

While the preferred embodiments have been particularly shown and described, the present specification shall not be limited to the particular embodiments described above, and it will be understood by an ordinary skilled person in the art that various changes in form and details may be made therein without departing from the spirit and scope of the present invention as defined by the following claims, and the alternative embodiments should not be individually understood from the inventive concept and prospect of the present invention.

### MODE FOR INVENTION

Various embodiments are described as a preferred form to implement the present invention.

### INDUSTRIAL APPLICABILITY

The present invention is used in a series of HDMI fields

It will be understood to those skilled in the art that various modifications and variations can be made in the present invention described so far, without departing from the spirit or scope of the inventions. Therefore, the present invention is intended to include modifications and variations of the present invention provided by the attached claims and the equivalence.

1. A method for transmitting and receiving data using a High Definition Multimedia Interface (HDMI) performed by a source device, comprising:
connecting to a sink device through the HDMI;
receiving Extended Display Identification Data (EDID) information from the sink device;
parsing the received EDID information, and determining an operating parameter; and
transmitting a message instructing to execute a video mute function to the sink device.

2. The method for transmitting and receiving data performed by a source device of claim 1, further comprising receiving video mute state information of the sink device.

3. The method for transmitting and receiving data performed by a source device of claim 2, wherein receiving the video mute state information is receiving the video mute state information in response to the message instructing to execute the video mute function.

4. The method for transmitting and receiving data performed by a source device of claim 2, further comprising requesting the video mute state information to the sink device,
wherein receiving the video mute state information is receiving the video mute state information in response to the request.

5. The method for transmitting and receiving data performed by a source device of claim 1, further comprising transmitting a message instructing to terminate the video mute function to the sink device.

6. The method for transmitting and receiving data performed by a source device of claim 1, wherein the message instructing to execute the video mute function is transmitted as a CEC message format.

7. A method for transmitting and receiving data using a High Definition Multimedia Interface (HDMI) performed by a sink device, comprising:
connecting to a source device through the HDMI;
transmitting Extended Display Identification Data (EDID) information to the source device; and
receiving a message instructing to execute a video mute function from the source device.

8. The method for transmitting and receiving data performed by a sink device of claim 7, further comprising transmitting video mute state information of the sink device to the source device.

9. The method for transmitting and receiving data performed by a sink device of claim 8, wherein transmitting the video mute state information is transmitting the video mute state information to the source device in response to the message instructing to execute the video mute function.

10. The method for transmitting and receiving data performed by a sink device of claim 8, further comprising receiving a request for the video mute state information from the source device,
wherein transmitting the video mute state information is transmitting the video mute state information to the source device in response to the request.

11. The method for transmitting and receiving data performed by a sink device of claim 7, further comprising receiving a message instructing to terminate the video mute function from the source device.

12. The method for transmitting and receiving data performed by a sink device of claim 7, further comprising:
receiving a Consumer Electronic Control (CEC) message from the source device;
determining whether to terminate an execution of the video mute function when performing an instruction included in the received CEC message; and
terminating or maintaining the execution of the video mute function based on a result of the determination.

13. The method for transmitting and receiving data performed by a sink device of claim 7, further comprising:
receiving an external input; and
terminating the execution of the video mute function.

14. The method for transmitting and receiving data performed by a sink device of claim 7, wherein the message instructing to execute the video mute function is transmitted as a CEC message format.

15. A source device for transmitting and receiving data using a High Definition Multimedia Interface (HDMI), comprising:
an HDMI transmitter configured to transmit and receive data through the HDMI; and
a MICOM configured to generate a signal for a data transmission,
wherein the source device is configured to:
connect to a sink device through the HDMI,
receive Extended Display Identification Data (EDID) information from the sink device,
parsing the received EDID information, and determining an operating parameter, and
transmitting a message instructing to execute a video mute function to the sink device.

16. The source device of claim 15, wherein the source device is further configured to receive video mute state information of the sink device.

17. The source device of claim 15, wherein the message instructing to execute the video mute function is transmitted as a CEC message format.

18. A sink device for transmitting and receiving data using a High Definition Multimedia Interface (HDMI), comprising:
an HDMI receiver configured to transmit and receive data through the HDMI; and
a MICOM configured to generate a signal for a data transmission,
wherein the sink device is further configured to:
connect to a sink device through the HDMI,
transmitting Extended Display Identification Data (EDID) information to the source device, and
receiving a message instructing to execute a video mute function from the source device.

19. The source device of claim 18, wherein the sink device is further configured to transmit video mute state information of the sink device to the source device.

20. The source device of claim 18, wherein the message instructing to execute the video mute function is transmitted as a CEC message format.
